(19) United States
(12) Patent Application Publication
(10) Pub. No.: US 2022/0140305 A1
(43) Pub. Date: May 5, 2022

(54) METHOD AND APPARATUS FOR PRODUCING AN ELECTRODE FOR AN ACCUMULATOR

(71) Applicant: Monbat New Power GmbH, Nordhausen (DE)

(72) Inventors: Michael Deutmeyer, Hamburg (DE); Klaus Brandt, Wiesbaden (DE)

(73) Assignee: Monbat New Power GmbH, Nordhausen (DE)

(21) Appl. No.: 17/431,733

(22) PCT Filed: Dec. 19, 2019
(86) PCT No.: PCT/EP2019/086480

§ 371 Date: Aug. 18, 2021

(30) Foreign Application Priority Data
Feb. 19, 2019 (DE) 10 2019 104 206.2

(51) Int. Cl. H01M 4/04

(52) U.S. Cl. CPC H01M 4/0411

(57) ABSTRACT

The invention relates to a method for producing an electrode for an accumulator, wherein an electrode compound is applied to a carrier, in particular a metal foil, by means of an extrusion process. In the extrusion process, the electrode compound is fed through an extrusion die by means of a feeding device. The electrode compound is prepared by mixing in a mixing device and passed on from the mixing device to the feeding device, fluctuations in the flow rate of electrode compound that is passed on from the mixing device to the feeding device being evened out.

The invention relates to a method and an apparatus for producing an electrode for a rechargeable battery according to the preambles of the independent claims.

Methods of the type in question have in common that, to produce an electrode, first an electrode compound is applied to a carrier. The application of this electrode compound, which—depending on how the method then proceeds—is further processed by means of downstream method steps, in particular drying steps, extraction steps and/or steps for infiltration with a suitable electrolyte, to form an electrode. The electrode compound may consist of a plurality of components. Here, the application of the electrode compound to the carrier represents a step that is not trivial and is relevant to the quality of the resultant rechargeable battery. In finished rechargeable batteries, the carriers, which may in particular be metal foils, are often wound up or folded and/or stacked into a multiplicity of layers. Therefore, thin layers of the electrode compound must be applied with great uniformity.

On an industrial scale, this is usually performed by a so-called “wet method”. This involves mixing a compound that is already of very low viscosity at comparatively low temperatures. It is then applied to a carrier, generally through slot dies and at room temperature.

A disadvantage of these methods is that the required viscosity of the compound to be applied is established by means of solvents. The solvent may be for example N-methyl-2-pyrrolidone (NMP). Although the compounds thus achieved, known as slurries, have good properties with regard to the application to the carrier, the solvents must be removed thereafter from the electrode compound. Use of the solvents causes environmental and health risks, which are undesired. In particular against the background of ever stricter environmental regulations, it is therefore desirable to find a method that eliminates or at least reduces the need for such harmful solvents to be used.

Therefore, for example, DE 10 2004 012 476 A1 discloses a method in which an electrode compound is produced at an elevated temperature using a flow promoter, while to the greatest extent doing without solvents, and is applied to a carrier. This takes place by the use of a so-called twin-screw extruder. This extruder is heatable. They have very high shearing rates. As a result, they can bring about sufficient mixing even of comparatively viscous materials. Therefore, when they are fed the constituents of the electrode compound, such twin-screw extruders are capable of initially processing them into a sufficiently homogeneous mixture and then feeding this compound through a likewise heatable extrusion die, by means of which the compound can be applied to the carrier.

However, it has been found in practice that the mass flow of the electrode compound that is passed on by the twin-screw extruder undergoes fluctuations over time. This is attributable to the type of construction of such a twin-screw extruder, which acts in this process as a mixing and feeding device. The lack of uniformity resulting from the fluctuations in the application of the electrode compound to the carrier have so far stood in the way of industrial-scale application of this method.

EP 2 744 019 A1 likewise discloses a method for the production of an electrode in which harmful solvents are—at least to the greatest extent—avoided. In the case of this method, however, first a molding material in the form of extruded pellets is produced. In a further method step, these pellets are melted at a later point in time and applied to the carrier by extrusion. This way of conducting the method is inefficient. On the one hand, repeated melting of the electrode compound causes increased energy consumption. On the other hand, the separation of the production of the pellets, in which the electrode compound is mixed, and the later application of the electrode compound to a carrier entails additional effort concerning the handling of the pellets between the two method steps.

The invention is therefore based on the object of providing a method and an apparatus for producing an electrode for a rechargeable battery which, while doing without harmful solvents to the greatest extent possible, allow uniform application of the electrode compound to the carrier and are additionally efficient.

The object is achieved by a method and an apparatus with the features of the independent claims. The features of the dependent claims concern advantageous embodiments.

The method for producing an electrode for a rechargeable battery provides that the electrode compound is first mixed in a mixing device and is passed on by the mixing device to the feeding device. In this case, the mixing device and/or the feeding device are in particular operated continuously. The passing on of the mass flow of electrode compound by the mixing device to the feeding device takes place in particular continuously. In this case, fluctuations of the mass flow of electrode compound passed on by the mixing device to the feeding device are compensated. The fact that a mass flow of electrode compound is passed on by the mixing device to the feeding device allows the method to be conducted uninterruptedly. This has the advantage, in particular over the “wet methods” described in the prior art, in which the production of the “slurry” takes place in batch mode and consequently discontinuously, and over a way of conducting the method in which first an intermediate product, such as for example the pellets mentioned at the beginning, are produced, that on the one hand the efficiency of the method becomes more efficient as a result of no longer required storage or reduced handling effort and on the other hand constant properties, in particular constant quality, can be better ensured.

This way of conducting the method allows the process steps of mixing the electrode compound and feeding it through the extrusion die to be separated from one another. As a result, the feeding device can be optimized to the extent that it feeds through the extrusion die a mass flow that is as constant as possible. This results in a correspondingly uniform application of the electrode compound to the carrier.

Correspondingly, the apparatus presented and described has a compensating device for compensating for fluctuations of a mass flow of electrode compound produced by the mixing device and passed on to the feeding device.

Separating the functions of “mixing the electrode compound” and “feeding the electrode compound through the extrusion die” into different method steps or different technical devices achieves the effect that the respective device or the respective method step can be optimized with regard to the effect to be achieved. The mixing of the electrode compound or the mixing device can be optimized with regard to best possible mixing together of the constituents and a correspondingly homogeneous resultant electrode compound. On the other hand, the feeding of the electrode compound through the extrusion die or the feeding device that is used for this can be optimized with regard to the most constant possible mass flow of the fed electrode compound. The extrusion die may be in particular a slot die.

Thus, to compensate for the fluctuations, electrode compound may be intermediately stored. For this purpose, the apparatus may have for example an intermediate storage device. The intermediate storage device may be for example a compensating container. The intermediate storage device makes it possible in particular that the mixing device feeds into the intermediate storage device with a mass flow that undergoes fluctuations over time, while the feeding device at the same time receives a constant mass flow, which at least undergoes smaller fluctuations than the mass flow produced by the mixing device. The fluctuations in the mass flow passed on by the mixing device are thus compensated by corresponding fluctuations of the filling level of the intermediate storage device. It has been found here that the intermediate storage device can in practice be made to comparatively small dimensions. This applies in particular whenever the fluctuations are small in relation to the overall mass flow of the electrode compound passed on by the mixing device and/or if these fluctuations occur regularly, in particular periodically. Both apply for example whenever the mixing device is a twin-screw extruder.

Alternatively and/or additionally, electrode compound may be returned to the mixing device to compensate for the fluctuations that the mass flow of electrode compound passed on by the mixing device has. For the apparatus, this means that it has in particular a return device for returning electrode compound to the mixing device.

This has the effect in particular that a partial flow is branched off from the mass flow of electrode compound that is passed on by the mixing device and undergoes fluctuations. This partial flow is returned to the mixing device, where it is mixed with the starting substances of the electrode compound. In particular if the mixing ratios of the respective constituents is kept constant over time, the returned electrode compound does not change the quality, in particular the composition of the mixture produced. The returned partial flow of the electrode compound in this case has fluctuations, which result from the fluctuations of the mass flow of electrode compound passed on by the mixing device and correspond to them. The rest of the mass flow of electrode compound passed on by the mixing device correspondingly has no fluctuations, or at least fewer fluctuations than the mass flow passed on by the mixing device. In this way, the feeding device can receive a constant, or at least more constant, mass flow of electrode compound than the mixing device passes on.

In this connection, it is favorable in particular if the mixing device and the feeding device are designed and/or operated in relation to one another in such a way that the mixing device passes on a greater mass flow of electrode compound than the feeding device receives. This difference makes it possible to branch off the partial flow required for the return.

It goes without saying that the two concepts presented above for realizing the compensation and the compensating device may be implemented in the same method or the same apparatus. This means that the method may provide that both electrode compound may be intermediately stored between the mixing and the feeding through the extrusion die and at the same time electrode compound is also returned. Correspondingly, an apparatus may also have both a return device and an intermediate storage device that are arranged between the mixing device and the feeding device. The arrangement between the feeding device and the mixing device does not necessarily refer here to the spatial arrangement of the devices in relation to one another, but rather to the arrangement along the flow path of the electrode compound.

The method may in particular provide that the electrode compound is applied to the carrier in the form of an uninterrupted strip, extending in the direction of application, of at least 2 m, in particular at least 5 m, in length. The compensation for the fluctuations of the mass flow of electrode compound passed on by the mixing device to the feeding device has the effect in particular that even such long strips of electrode compound can be applied uniformly. The uniformity of the application applies here in particular to the straightest possible formation of the edge of the electrode compound that extends parallel to the direction of application. The direction of application should be understood in this connection as meaning in particular the direction in which the carrier is moved past the extrusion die while the electrode compound is being applied. The relative movement has the effect that the strip of electrode compound builds up on the carrier in this direction of application.

The method may provide in particular that the electrode compound is applied to the carrier in such a way that there forms on the carrier along the electrode compound a strip that is free of electrode compound, extending parallel to the direction of application of the electrode compound. Such a strip that is free of electrode compound may serve for example for the electrical contact of the respective electrode. It is particularly important in this connection that there forms a defined and straightest possible edge of the electrode compound that extends parallel to the direction of application. Only then is it ensured that a defined strip that is free of electrode compound forms on the carrier.

The apparatus may have a measuring device for measuring a measured variable concerning the electrode compound passed on by the mixing device to the feeding device. Correspondingly, the method may provide that a measured variable concerning the electrode compound passed on by the mixing device to the feeding device is measured. The measured variable may be in particular a filling level of the intermediate storage device and/or a mass flow of electrode compound returned by the return device. As a result, in particular knowledge can be gained concerning the extent to which the coordination between the mixing device and the feeding device with regard to the respectively handled mass flows of electrode compound are coordinated with one another, and in particular the extent to which sustained continuous operation is possible can be monitored, and/or whether electrode compound is accumulated or depleted in the intermediate storage device or in the circuit formed by the return. This may be the case in particular whenever the mass flows that are passed on by the mixing device and/or are received by the feeding device have not been coordinated with one another sufficiently accurately.

In connection with the method described here and the apparatus described here, in particular the measuring described above, a mass flow should not necessarily be understood as meaning that the actual—molar—amount of substance is recorded or measured; rather, a mass flow should be understood as meaning a mass flow in the broadest sense, i.e. in particular a mass flow that is represented by a suitable representative variable, for example a mass and/or volume flow as a measured and/or controlled variable that is actually used.

In particular, the apparatus may be controlled in dependence on the measured variable. The apparatus may have for this a correspondingly configured closed-loop and/or open-loop control device. This may include a closed-loop control, which serves in particular for maintaining a stable state in continuous operation. In particular, for this, the closed-loop and/or open-loop control device may serve for the closed-loop and/or open-loop control of a metering device for metering a constituent of the electrode compound. In this connection, the metering device may also be suitable for metering a plurality of constituents or there may also be a plurality of metering devices. The metering devices serve in particular for passing on the constituent or the constituents of the electrode compound to the mixing device. Such metering devices may serve primarily for setting the quantitative ratios of individual constituents of the electrode compound. In addition, however, the mass flow of the overall amount of constituents passed on to the mixing device may also be controlled in an open-loop and/or closed-loop manner. In this way, together with the measuring or measuring device described above, it can be ensured that the filling level of an intermediate storage device and/or the mass flow of electrode compound returned by a return device varies within a tolerance range that is in particular suitable for stable, sustained and continuous operation.

In particular, the method may provide that the electrode compound is kept in a flowable state between leaving the mixing device and entering the feeding device. This applies in particular to the time during which the electrode compound is intermediately stored or to the point in time of branching off a partial flow of the electrode compound for its return to the mixing device. Keeping the compound in a flowable state makes it possible for the process to be conducted in a stable continuous manner.

The method may provide degassing of the electrode compound. This may be advisable in particular to ensure that the electrode compound does not have any gas inclusions after its application to the carrier. Such gas inclusions may occur for example during the mixing of the components of the electrode compound. Likewise, gas inclusions may occur due to the evaporation of impurities. These impurities may be for example water. The degassing may in particular already take place during the mixing of the constituents of the electrode compound and/or during the intermediate storage of the electrode compound.

In particular, the method provides that the temperature of the electrode compound between leaving the mixing device and entering the feeding device is always at least 80° C., in particular at least 90° C., and/or at most 160° C., in particular at most 120° C. This concerns in particular the temperature of the electrode compound during intermediate storage and/or the temperature of the electrode compound during the branching off of a partial flow for return to the mixing device.

In particular, the method provides that the temperature of the electrode compound in the mixing device is at least 80° C., in particular at least 90° C., and/or at most 140° C., in particular at most 120° C.

In particular, the method provides that the temperature of the electrode compound in the feeding device and/or the extrusion die is at least 80° C., in particular at least 90° C., and/or at most 150° C., in particular at most 130° C.

It has been found that suitable rheological properties can be achieved within these temperatures, in particular the electrode compound can be kept in a flowable state.

The apparatus may have a heating device. Here, the heating device serves in particular for heating the mixing device, the compensating device, the feeding device and/or the extrusion die. The heating device makes it possible in particular for the electrode compound to be kept in a flowable state from when it is mixed in the mixing device to when it leaves the extrusion die. Correspondingly, heating of the electrode compound as provided by the present method takes place, in particular from when it is mixed to when it leaves the extrusion die.

The, in particular continuously operating, mixing device may be a multi-screw extruder. Multi-screw extruders have very good properties with regard to the mixing together of viscous or pasty materials because of the high shearing rates that they produce in the materials fed through the multi-screw extruders. Therefore, when they are used as a mixing device, the multi-screw extruders lead to very good homogeneity of the electrode compounds produced. It has proven to be particularly advantageous in this connection if the mixing device is a twin-screw extruder.

The feeding device is in particular a positive displacement pump. Positive displacement pumps have in particular advantages with regard to the feeding of media with comparatively high viscosities. In particular, the feeding device may be a gear pump. It has been found that gear pumps can in particular produce a very constant mass flow.

In particular, the rheological characteristics of the electrode compound together with the characteristics of the method and/or the apparatus are chosen such that the electrode compound within the extrusion die is flowable, because of the shearing forces prevailing there, and loses this flowability directly after leaving the extrusion die—and consequently after the shearing forces cease. This has a positive effect on the electrode compound retaining the cross section predetermined by the form of the extrusion die when it is applied to the carrier.

The electrode compound may have a base compound and a plasticizer as essential constituents. In this case, the base compound contains in particular those constituents of the electrode compound that form the electrode after later, at least partial, removal of the plasticizer. The electrode compound, in particular the base compound, has an active material as a constituent. The active material may in the case of the anode be in particular graphite and/or in the case of the cathode be lithium nickel manganese cobalt oxide, lithium nickel cobalt aluminum oxide or lithium iron phosphate (LiFePO4). Other active materials, in particular lithium compounds, are also conceivable. Referred to as the active material are the chemically active substances in an electrode that are responsible for the energy storage, in which they undergo chemical transformations, involving giving off and/or taking up electrical charge carriers, when the rechargeable battery is being charged and/or discharged.

The proportion by mass of the active material in the base compound is at least 88%, and/or at most 97%.

The electrode compound, in particular the base compound, may also contain an additive for improving the electrical conductivity. This additive may be for example carbon black and/or graphite. The proportion by mass of the additive in the base compound may be at least 1.5%, and/or at most 5%.

The electrode compound, in particular the base compound, may contain a binder. The binder may be a polymer, in particular a fluoropolymer. The proportion by mass of the binder in the base compound may be at least 1.5%, in particular at least 3%, and/or at most 7%, in particular at most 5%.

The electrode mass may also contain a plasticizer. The plasticizer may be for example a substance that has a suitable phase transition behavior. This should be understood as meaning in particular a substance of which the melting point is at most 80° C., in particular at most 35° C., and/or of which the boiling point is at least 120° C., in particular at least 140° C. Substances with such a phase transition behavior are suitable for keeping the electrode compound in a plastic or flowable state during the mixing or during their feeding through the extrusion die, but at the same time for ensuring the formation of a stable layer on the carrier directly after leaving the extrusion die, in particular without risking gas formation during the method steps carried out at an elevated temperature.

The proportion by mass of the plasticizer may be chosen in particular in dependence on the properties of the constituents of the base compound. Parameters such as the grain size, the size of the surface and the amount and type of additional substances, such as binder and/or additive for improving the electrical conductivity, may be taken into consideration here. Similarly, the amount and type of active material plays a role. It has proven to be advantageous in this connection if, in the case of using graphite as the active material for the anode, the proportion by mass of the plasticizer is at least 14%, in particular at least 20%, and/or at most 42%, in particular at most 40%. In the case of the cathode, in particular in the case of a lithium iron-phosphate cathode, the proportion of the plasticizer may be at least 30%, in particular at least 35%, and/or at most 50%, in particular at most 42%.

In particular, the plasticizer may be ethylene carbonate. According to the prior art, ethylene carbonate is already used in electrolytes of rechargeable batteries of the type in question, and is therefore unproblematic for the rechargeable battery, in particular for the way in which it functions. In addition, because of the position of its melting point, ethylene carbonate has a temperature-dependent behavior, which makes it possible that the ethylene carbonate acts as a plasticizer at the temperatures that prevail between the mixing device and the extrusion die, loses its effect, at least to a great extent, as a plasticizer after the cooling down of the electrode compound on the carrier, in particular after cooling down to room temperature.

The method may provide that the electrode compound is cooled after being applied to the carrier. This may in particular involve cooling down to room temperature.

The carrier may be in particular a metal foil. The metal foil takes the form in particular of an elongate strip. This is in particular moved past the extrusion die while the electrode compound is being applied to the carrier. The metal may be in particular copper and/or aluminum. The carrier may be stored in particular on a roller, from which it is unrolled in order to be transported to the extrusion die.

There may be a measuring device for recording the loading of the carrier with electrode compound. This may be in particular a measuring device for measuring the thickness of the electrode compound applied to the carrier. In particular, the measuring device may be a so-called “beta gauge”. This is a measuring device for radiometric thickness measurement, which measures the thickness of the transradiated layer on the basis of beta radiation. In principle, however, other thickness measuring methods are also conceivable, in particular other radiometric thickness measuring methods.

The apparatus may have a control device, which is configured to control the apparatus, in particular the feeding device, in dependence on the measured values recorded by the measuring device. As a result, fluctuations of the mass flow of the electrode compound can be reduced still further.

The method may provide that the plasticizer is removed, at least to a great extent, from the electrode compound. This may in particular involve a porosity being produced in the electrode. The removal of the plasticizer may take place in particular by the action of heat. For this, the apparatus may in particular have a heating device. The heating device may be for example an infrared heating device. The action of heat may in this case have the effect in particular that the plasticizer evaporates.

It is possible that the plasticizer is re-used. This may take place for example by the plasticizer, in particular if it has initially been evaporated, being removed with a gas flow and condensed out from it. The gas flow may be in particular an air flow.

It is possible that, according to the method described above, the electrode compound is applied on both sides of the carrier material.

Further practical embodiments and advantages of the invention are described below in connection with the drawings, in which:

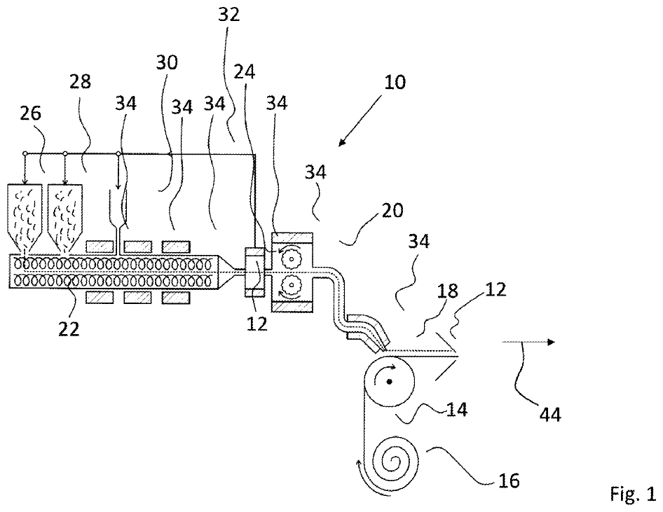

FIG. 1 shows a simplified graphic representation of a first part of an apparatus for producing an electrode,

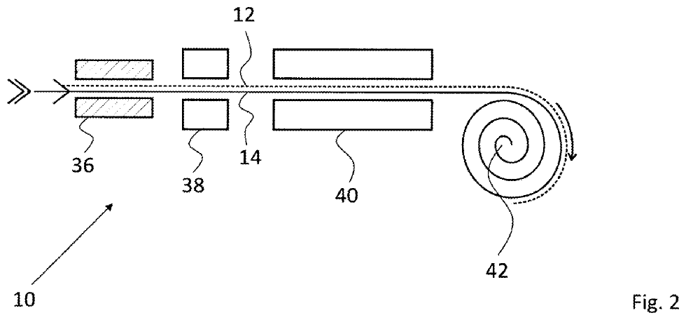

FIG. 2 shows the second part, going together with the part represented in FIG. 1, of an apparatus for producing an electrode,

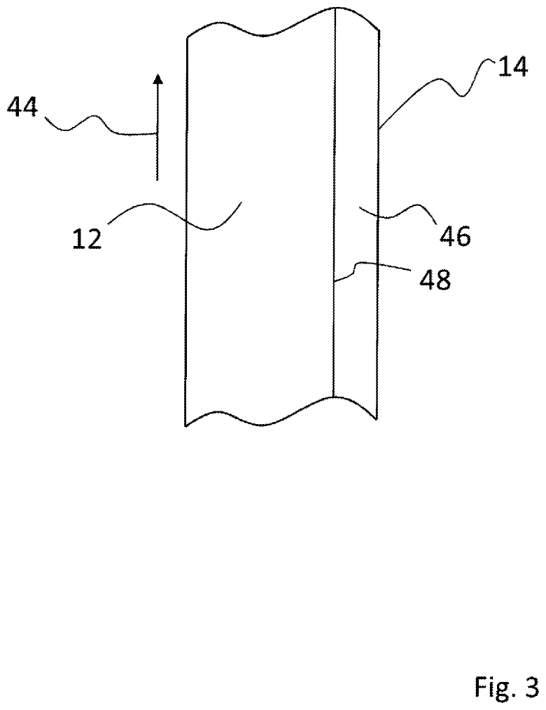

FIG. 3 shows a plan view of a portion of a strip of electrode compound applied to a carrier.

The apparatus 10, given by way of example, is suitable and intended for carrying out a method in which an electrode compound 12 is applied to a carrier 14. The carrier 14 may be, as in the example presented, strip-shaped and in a wound-up form. Correspondingly, the apparatus 10 may have an unwinding device 16 for unwinding the carrier 14.

The electrode compound 12 is applied to the carrier 14 by means of an extrusion die 18. For this, the electrode compound 12 is fed through the extrusion die 18 by means of the feeding device 20. As only schematically indicated graphically in the example shown, the feeding device 20 may be a gear pump. The carrier 14 is in this case moved past the extrusion die 18 in the direction of application 44.

The apparatus 10 also has a mixing device 22. As only schematically indicated graphically in the example shown, this may be formed as a twin-screw extruder. The mixing device 22 mixes the electrode compound 12, which is then passed on by the mixing device 22 to the feeding device 20. In this case, fluctuations in the mass flow of the electrode compound 12 passed on by the mixing device 22 to the feeding device 20 are compensated by a compensating device 24. As in the example shown, the compensating device 24 may be an intermediate storage device. This may intermediately store part of the mass flow of electrode compound 12 passed on by the mixing device 22 to the feeding device 20. The fluctuations in the mass flow are as it were “smoothed”.

As in the example shown, the apparatus 10 may have a plurality of metering devices 26, 28 for metering various constituents of the electrode compound 12. Likewise, the apparatus 10 may have a metering device 30 for metering the plasticizer. With the metering devices 26, 28, 30, the corresponding constituents can in each case be metered into the mixing device 22, i.e. in particular the mass flow can be controlled in an open-loop and/or closed-loop manner. The apparatus 10 may in this connection have a closed-loop and/or open-loop control 32, which is in particular designed to control the mass flows passed on by the metering devices 26, 28, 30 to the mixing device 22 in dependence on a measuring device that is not represented any more specifically. The measuring device that is not represented any more specifically may be in particular a measuring device for measuring the filling level in the intermediate storage device.

The mixing device 22, the compensating device 24, the feeding device 20 and/or the extrusion die 18 may in each case have a heating device 34. In particular, the mixing device 22 may have a plurality of heating devices 34, as represented in the case of the apparatus 10 given by way of example. In this way, for example, different heating zones can be realized.

Directly after the application of the electrode compound 12 to the carrier 14, it may be fed to a cooling device 36, as in the case of the apparatus 10 represented by way of example. In this connection, the change from FIG. 1 to FIG. 2 is only for technical representational reasons. In fact, the composite that is formed by the application, comprising the carrier 14 and the electrode compound 12, is further transported directly between the part-apparatuses 10 represented in FIGS. 1 and 2.

As represented in the example, the composite thus formed, comprising the carrier 14 and the electrode compound 12, may be fed to a layered measuring device 38. The result of the layer thickness measurement, in particular the result of the layer thickness measurement of the layer of the electrode compound 12, can likewise be used in connection with a closed-loop and/or open-loop control of the apparatus 10, in particular a metering device 26, 28 and/or 30.

As in the example represented, the apparatus 10 may have a heating device 40. This may be for example an infrared oven. The heating device serves in particular for removing the plasticizer, at least partially, from the electrode compound 12. This also has the effect in particular of generating a porosity, which can at a later point in time be infiltrated with an electrolyte.

As shown in the example, the apparatus 10 may have a winding-up device 42 for winding up the electrode formed by the composite comprising the carrier 14 and the layer of electrode compound 12 applied to it.

In FIG. 3, a portion of a carrier 14 with a strip of electrode compound 12 applied to it is represented. The strip of electrode compound 12 extends parallel to the direction of application 44. Also extending parallel to the strip of electrode compound 12 and to the direction of application 44 is a strip 46 that is free of electrode compound. As a result of the compensation for the fluctuations of the mass flow passed on by the mixing device to the feeding device, the edge 48 is formed as particularly straight and regular.

According to a first example, the electrode compound for a cathode that is mixed in the mixing device may be a mixture of a base compound and a plasticizer. The proportion by mass of the plasticizer in this mixture may be for example 24%. The plasticizer may be ethylene carbonate. The base compound may contain two different binders in proportions by mass of 4% and 2%, graphite and carbon black as additives for increasing the conductivity in proportions by mass of 3% each and lithium nickel cobalt aluminum oxide as an active material in a proportion by mass of 88%, in each case with respect to the base compound.

According to a second example, the electrode compound for a cathode that is mixed in the mixing device may be a mixture of a base compound and a plasticizer. The proportion by mass of the plasticizer in this mixture may be for example 35%. The plasticizer may be ethylene carbonate. The base compound may contain a binder in a proportion by mass of 7%, carbon black as an additive for increasing the conductivity in a proportion by mass of 5% and lithium iron phosphate as an active material in a proportion by mass of 88%, in each case with respect to the base compound.

According to a third example, the electrode compound for an anode that is mixed in the mixing device may be a mixture of a base compound and a plasticizer. The proportion by mass of the plasticizer in this mixture may be for example 38%. The plasticizer may be ethylene carbonate. The base compound may contain a binder in a proportion by mass of 6.5%, carbon black as an additive for increasing the conductivity in a proportion by mass of 4.5% and graphite as an active material in a proportion by mass of 89%, in each case with respect to the base compound.

The features of the invention disclosed in the present description, in the drawings and in the claims may be essential to the implementation of the invention in its various embodiments both individually and in any desired combinations. The invention is not restricted to the embodiments described. It can be varied within the scope of the claims and taking into consideration the knowledge of the relevant person skilled in the art.

### LIST OF REFERENCE SIGNS

10 Apparatus

12 Electrode compound

14 Carrier

16 Unwinding device

18 Extrusion die

20 Feeding device

22 Mixing device

24 Compensating device

26 Metering device

28 Metering device

30 Metering device

32 Closed-loop/open-loop control

34 Heating device

36 Cooling device

38 Layer thickness measuring device

40 Heating device

42 Winding-up device

44 Direction of application

46 Strip free of electrode compound

48 Edge

1. A method for producing an electrode for a rechargeable battery, wherein an electrode compound (12) is applied to a carrier (14), in particular a metal foil, by means of an extrusion process, wherein, in the course of the extrusion process, the electrode compound (12) is fed through an extrusion die (18) by means of a feeding device (20), characterized
in that the electrode compound (12) is mixed in a mixing device (22) and is passed on by the mixing device (22) to the feeding device (20),
wherein fluctuations of the mass flow of electrode compound (12) passed on by the mixing device (22) to the feeding device (20) are compensated.

2. The method as claimed in claim 1, characterized in that, to compensate for the fluctuations, electrode compound (12) is intermediately stored.

3. The method as claimed in claim 1 or 2, characterized in that, to compensate for the fluctuations, electrode compound (12) is returned to the mixing device (22).

4. The method as claimed in one of the preceding claims, characterized in that the electrode compound (12) is applied to the carrier (14) in the form of an uninterrupted strip, extending in the direction of application (44), of at least 2 m, in particular at least 5 m, in length.

5. The method as claimed in one of the preceding claims, characterized in that the electrode compound (12) is applied to the carrier (14) in such a way that there forms on the carrier (14) along the electrode compound (12) a strip (46) that is free of electrode compound, extending parallel to the direction of application of the electrode compound.

6. The method as claimed in one of the preceding claims, characterized in that the electrode compound (12) is kept in a flowable state between leaving the mixing device (22) and entering the feeding device (20), in particular during intermediate storage.

7. The method as claimed in one of the preceding claims, characterized in that the temperature of the electrode compound (12) between leaving the mixing device (22) and entering the feeding device (20), in particular during intermediate storage, is always at least 80° C., in particular at least 90° C., and/or at most 140° C., in particular at most 120° C.

8. The method as claimed in one of the preceding claims, characterized in that the electrode compound (12) has ethylene carbonate as a plasticizer.

9. An apparatus (10) for producing an electrode for a rechargeable battery, in particular by a method as claimed in one of the preceding claims, wherein the apparatus has a mixing device (20) for mixing an electrode compound (12) and a feeding device (20) for feeding the electrode compound (12) through an extrusion die (18),
characterized
in that the apparatus (10) has a compensating device (24) for compensating for fluctuations of a mass flow of electrode compound (12) produced by the mixing device (22) and passed on to the feeding device (20).

10. The apparatus (10) as claimed in claim 9, characterized in that the apparatus (10), in particular the compensating device (24) and the intermediate storage device, has a compensating container, for compensating for the fluctuations.

11. The apparatus (10) as claimed in claims 9 to 10, characterized in that the apparatus (10), in particular the compensating device (24), for compensating for the fluctuations has a return device for returning electrode compound (12) to the mixing device (22).

12. The apparatus (10) as claimed in one of claims 9 to 11, characterized in that the mixing device (22) is a multi-screw extruder, in particular a twin-screw extruder.

13. The apparatus (10) as claimed in one of claims 9 to 12, characterized in that the feeding device (20) is a positive displacement pump, in particular a gear pump.

14. The apparatus (10) as claimed in one of claims to 13, characterized in that the apparatus (10) has a measuring device (38) for measuring a measured variable concerning the electrode compound (12) passed on by the mixing device (22) to the feeding device (20), in particular for measuring a filling level of the intermediate storage device and/or for measuring a mass flow returned by the return device.

15. The apparatus (10) as claimed in claim 14, characterized in that the apparatus (10) has a closed-loop and/or open-loop control device (32) for controlling the apparatus (10), in particular a metering device (26, 28, 30) for metering a constituent of the electrode compound (12), in dependence on the measured variable.
